(19) United States
(12) Patent Application Publication
(10) Pub. No.: US 2011/0194609 A1
(43) Pub. Date: Aug. 11, 2011

(54) Selecting Predicted Motion Vector Candidates

(76) Inventors: Thomas Rusert, Kista (SE); Jacob Ström, Stockholm (SE); Kenneth Andersson, Gavle (SE); Per Wennersten, Arsta (SE); Rickard Sjöberg, Stockholm (SE)

(21) Appl. No.: 13/022,170

(22) Filed: Feb. 7, 2011

Related U.S. Application Data
(60) Provisional application No. 61/301,649, filed on Feb. 5, 2010.

(30) Foreign Application Priority Data
Dec. 23, 2010 (EP) PCT/EP2010/070679

(51) Int. Cl. H04N 7/32

(52) U.S. Cl. 375/240.16; 375/E07.243

(57) ABSTRACT

There is provided a method of selecting PMV candidates, wherein each PMV candidate corresponds to a motion vector used for coding of a previous block, said previous block having a distance from a current block. The method comprises identifying allowed distance values of distances between the current block and the previous block. The method further comprises selecting a set of PMV candidates as a subset of the set of previously coded motion vectors that were used for previous blocks having an allowed distance from the current block.

### TECHNICAL FIELD

The present application relates to a method of selecting PMV candidates, a video encoding apparatus, a video decoding apparatus, and a computer-readable medium.

### BACKGROUND

Recent video coding standards are based on the hybrid coding principle, which comprises motion compensated temporal prediction of video frames and coding of frame residual signals. For efficient motion compensated temporal prediction, block-based motion models are used to describe the motion of pixel blocks across frames. Each motion compensation block is assigned one motion vector (for uni-predictive temporal prediction, such as in P frames) or two motion vectors (for bi-predictive temporal prediction, such as in B frames). These motion vectors are coded in the video bit stream along with the frame residual signals.

At high compression ratios (or equivalently, low video bitrates), motion vector coding takes a large part of the total amount of bits, especially in recent video coding standards such as H.264/AVC where small motion compensation block sizes are used. Typically, lossless predictive coding of motion vectors is used, i.e. coding of a motion vector MV consists of first building a motion vector predictor PMV for the vector to be coded and then transmitting the difference: DMV, where DMV=MV−PMV between the motion vector and the motion vector predictor.

In H.264/AVG, a PMV is derived as the median of the motion vectors of three spatially neighboring blocks. Other approaches consider also temporally neighboring blocks (i.e. co-located in neighboring frames) for motion vector prediction. Instead of using a fixed rule for building PMV, recently approaches have been presented that explicitly signal a PMV to be used out of a set of PMV candidates, PMV_CANDS. Although this requires additional bits to signal one candidate out of the set, it can overall save bits for motion vector coding, since DMV coding can be more efficient. That is, identifying a PMV and signaling DMV can take fewer bits than independently signaling the MV.

The efficiency of motion vector coding schemes which use PMV candidate signaling depends on the suitability of the available candidates in PMV_CANDS. That is, the construction of the candidate list has a major impact on the coding performance. Existing approaches typically use motion vectors from spatially surrounding blocks or temporally neighboring blocks (co-located blocks in neighboring frames). Such construction of PMV_CANDS, i.e. considering only the few surrounding blocks as a source of motion vector predictors, can be sub-optimal.

The number of candidates in PMV_SANDS, i.e. the “length” of PMV_SANDS, has a major impact on coding efficiency, too. The reason is that the higher the number of candidates, the higher the number of bits required for signaling one of the candidates, which in turn causes additional overhead and thus reduced compression efficiency. Existing approaches assume a fixed number of candidates in PMV_SANDS (e.g. the spatially neighboring motion vectors) valid for coding of a video frame or sequence, and the number of candidates may only be reduced if some of the candidates are identical.

Motion vector coding can require a significant proportion of an available bitrate in video coding. Increasing the number of PMV candidates may reduce the size of the difference value (DMV) that must be signaled but requires more signaling to identify the particular PMV. Accordingly, to improve video coding efficiency an improved method and apparatus for selecting PMV candidates is required.

“An efficient motion vector coding scheme based on minimum bitrate prediction” by Sung Deuk Kim and Jong Beom Ra, published in IEEE Trans. Image Proc., Volume 8, Issue 8, August 1999 Page(s):1117-1120; describes a motion vector coding technique based on minimum bitrate prediction. A predicted motion vector is chosen from the three causal neighboring motion vectors so that it can produce a minimum bitrate in motion vector difference coding. Then the prediction error, or motion vector difference, and the mode information for determining the predicted motion vector at a decoder are coded and transmitted in order.

“Competition-Based Scheme for Motion Vector Selection and Coding” by Joel Jung and Guillaume Laroche, documented by the Video Coding Experts Group (VCEG) of ITU-Telecommunications Standardization Sector, and having document number VCEG-AC06, Klagenfurt, Austria, July 2006; describes a method for the reduction of the motion information cost in video coding. Two modifications made on the selection of the motion vector predictor are disclosed: improvement of the prediction of the motion vectors that need to be transmitted; and a Skip mode to increase the number of macro-blocks that do not require any motion information to be sent.

US 2009/0129464 in the name of Jung et al. relates to adaptive coding and decoding. This document describes a method of transmitting an image portion, whereby in a coding phase analyzing a coding context, a parameter of a group of prediction functions that can be used for coding is adapted. A first predicted descriptor is formed using a selected prediction function. A residue between the first predicted descriptor and the current descriptor is determined and transmitted.

### SUMMARY

Accordingly, there is provided a method of selecting PMV candidates, wherein each PMV candidate corresponds to a motion vector used for coding of a previous block, said previous block having a distance from a current block. The method comprises identifying allowed distance values of distances between the current block and the previous block. The method further comprises selecting a set of PMV candidates as a subset of the set of previously coded motion vectors that were used for previous blocks having an allowed distance from the current block.

A PMV candidate list is created by selecting a subset of the motion vectors previously used for previous blocks. Restricting the previous blocks that are considered reduces the number of previous motion vectors that must be considered meaning that less computation is needed, improving the processor efficiency of the coding.

Identifying allowed distance values means that certain distance values may not be allowed. These not-allowed distance values result in skipped layers of blocks. The size of the PMV candidate list is limited because a very large list would require long code words to identify which PMV candidate to use Skipping layers can provide increased coding efficiency by ensuring that not only the nearest neighbor previous blocks are considered, but also previous blocks. This allows a candidate list to be produced using motion vectors from a wide range of previous blocks, but that is not excessively long.

At least one group of PMV candidates may have a common distance value. The method disclosed herein may also be used for managing PMV candidates.

The method may further comprise identifying allowed positions of previous blocks, and wherein the selected set of PMV candidates comprises a subset of the set of previously coded motion vectors that were used for previous blocks having an allowed distance from the current block and an allowed position.

The allowed positions may be are corner and middle block positions. A previous block at a corner position is offset from a current block position by an equal distance in a horizontal direction and a vertical direction. A previous block at a middle position is either horizontally aligned or vertically aligned with a current block position. In a system where coding is performed by horizontal lines of pixels starting in the top left corner, the allowed block positions may comprise: blocks horizontally aligned with and offset to the left of the current block; blocks vertically aligned with and offset above the current block; and blocks offset to the left and above the current block by the same distance. The allowed distance values and/or the allowed positions may be predetermined.

The allowed distance values may comprise elements of a series, the elements in the series increasing at a rate greater than a linear increase. This allows the PMV candidate list to be created comprising a large number of PMV candidates associated with previous blocks near the current block, but allowing for a few PMV candidates to be included which are associated with previous blocks distant from the current block. This is advantageous because while it is more likely that a motion vector associated with a previous block close to the current block will be the best PMV, in some circumstances a more distant previous block may provide an optimal motion vector to use as the PMV.

The rate of increase of the allowed distance values may be measured per discrete distance value, per block, or per allowed block position.

The values of distance for the selected set of PMV candidates may increase according to at least one of: a geometric progression; and an exponential progression.

The method may further comprise moving unnecessary PMV candidates from the set of PMV candidates.

Any unnecessary PMV candidates may be removed from the set of PMV candidates. This ensures the length of the list is not unnecessarily long, which would reduce coding efficiency. A PMV candidate may be determined to be unnecessary if it at least one of the following conditions is fulfilled: the PMV candidate is a duplicate of another PMV candidate in the set; the PMV candidate is determined to be within a threshold distance of an existing PMV candidate; and the PMV candidate would never be used because at least one alternative PMV candidate will allow motion vectors to be coded using fewer bits.

Further, a set of PMV candidates may be determined to be unnecessary if removing them from the list of PMV candidates would result in at most N extra bits being required to encode any single motion vector, wherein N is a predetermined threshold Removing a set of PMV candidates from the list of PMV candidates allows the remaining PMV candidates to be signaled using shorter codes and so fewer bits. However, removing a set of PMV candidates from the list of PMV candidates will result in some motion vectors having a larger difference vector, which will require more bits to encode. Over the average of several motion vectors, the saving in signaling which PMV candidate to use can exceed the, at most, N extra bits required to signal some motion vectors.

The method may be for video encoding or for video decoding, wherein the current block is the block being encoded or decoded respectively.

There is further provided a video encoding apparatus comprising a processor. The processor is arranged to identify allowed distance values of distances between a current block and a previous block, wherein each PMV candidate corresponds to a motion vector used for coding of a previous block, said previous block having a distance from the current block. The processor is further arranged to select a set of PMV candidates as a subset of the set of previously coded motion vectors that were used for previous blocks having an allowed distance from the current block.

There is further provided a video decoding apparatus comprising a processor. The processor is arranged to identify allowed distance values of distances between a current block and a previous block, wherein each PMV candidate corresponds to a motion vector used for coding of a previous block, said previous block having a distance from the current block. The processor is further arranged to select a set of PMV candidates as a subset of the set of previously coded motion vectors that were used for previous blocks having an allowed distance from the current block.

There is further provided a computer-readable medium, carrying instructions, which, when executed by computer logic, causes said computer logic to carry out any of the methods disclosed herein.

### BRIEF DESCRIPTION OF THE DRAWINGS

An improved method and apparatus for selecting PMV candidates will now be described, by way of example only, with reference to the accompanying drawings, in which:

FIG. 1 shows a video coding and transmission system;

FIGS. 2a and 2b show the use of a PMV candidate list during encoding and decoding respectively;

FIGS. 3a to 3n illustrate possible scan patterns and distance measurements for a plurality of blocks surrounding a current block;

FIG. 4 shows an example of two PMV candidates;

FIG. 5 shows the bit cost of coding motion vectors using the example motion vectors of FIG. 4; and

FIG. 6 illustrates a method disclosed herein.

### DETAILED DESCRIPTION

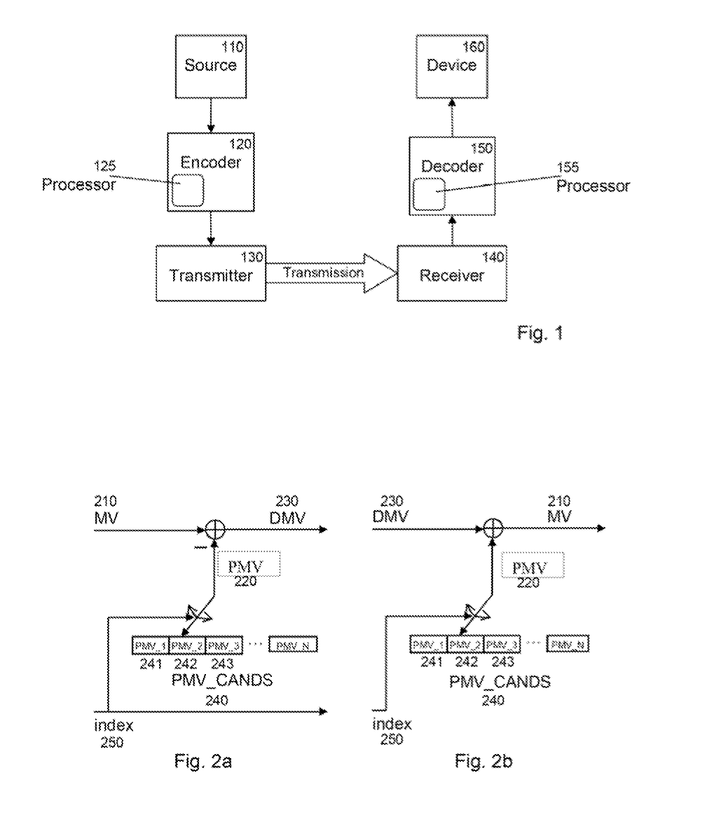

FIG. 1 shows a video coding system wherein a video signal from a source 110 is ultimately delivered to a device 160. The video signal from source 110 is passed through an encoder 120 containing a processor 125. The encoder 120 applies an encoding process to the video signal to create an encoded video stream. The encoded video stream is sent to a transmitter 130 where it may receive further processing, such as packetization, prior to transmission. A receiver 140 receives the transmitted encoded video stream and passes this to a decoder 150. Decoder 150 contains a processor 155, which is employed in decoding the encoded video stream. The decoder 150 outputs a decoded video stream to the device 160.

The methods disclosed herein are performed in the encoder during encoding, and also in the decoder during decoding. This is achieved even though the generation of the signaling bits is done in the encoder. During decoding the decoder parses the bits and mimics the encoder in order to achieve encoder/decoder synchronization. Because the encoder and decoder follow the same rules for creating and modifying the set of PMV candidates, the respective lists of PMV candidates stored in the encoder and decoder maintain synchronization Still, explicit signaling of PMV candidate lists may be performed under certain circumstances.

The described methods assume coding of a motion vector (MV) 210 using predictive coding techniques, where a predicted motion vector (PMV) 220 is used to predict a MV 210, and the prediction error or difference (DMV) 230 is found according to DMV=MV−PMV. DMV 230 is signaled from the encoder 120 to the decoder 150. Additionally, a code “index” 250 is sent to select a particular PMV candidate, in this case 242 from a list of PMV candidates, PMV_CANDS 240 as shown in FIG. 2a. The index 250 may be sent once together with each transmitted motion vector MV 210, i.e. per sub-block (e.g. 8×8 pixel block). Likewise, the index may be sent for groups of motion vectors, e.g. per macroblock (16×16 block).

The list of PMV candidates, PMV_CANDS (240) has N elements PMV_1 (241), PMV_2 (242), PMV_3 (243) etc. The list PMV_CANDS 240 is identically available at both the encoder 120 and the decoder 150. Using the transmitted index, the decoder 150 can determine the PMV 220 as used in the encoder as shown in FIG. 2b, and thus may reconstruct MV=DMV+PMV.

There are two major operations used for construction of the set of PMV candidates 240, initialization and update.

Initialization means that a certain pre-defined state of the list is established. A PMV_CANDS list may be initialized e.g. as an empty list (zero entries) or as a list with one or more pre-defined entries such as the zero vector (0,0). Update means that one or more motion vectors are added to an existing PMV_SANDS list. A PMV_CANDS list may be updated to include previously coded motion vectors MV. At the encoder, when encoding a current block, PMV_CANDS may contain, besides any pre-defined initialization vectors, motion vectors associated with previously encoded blocks in the video. By restricting the possible candidates in PMV_CANDS to pre-defined vectors and previously coded vectors, the decoder can derive the list PMV_CANDS in the same way as the encoder.

Alternatively, one or more motion vector candidates that have not been encoded previously may be added into the PMV_CANDS list at the encoder, and then those motion vectors will be explicitly signaled to the decoder for use with PMV_CANDS, such that PMV_CANDS can be updated in the same way both at the encoder and the decoder.

The PMV_CANDS list used for coding a motion vector associated with a current motion compensation block can be dynamically generated specifically for the current motion compensation block, i.e. without consideration of the PMV_CANDS lists used for coding of MVs associated with motion compensation blocks previously coded. In that case, before a block is processed, a PMV_CANDS list is initialized and then updated with a number of previously coded or pre-defined motion vectors. Alternatively, a PMV_CANDS list may be initialized once (for example before the start of video encoding/decoder, or before a frame is processed or after a number of macroblocks have been encoded in a frame), and then used for coding of more than one motion vector, the advantage being that the possibly complex process of deriving the PMV_CANDS list need only be processed once for coding of a set of motion vectors. When being used for coding of more than one motion vector, the PMV_CANDS list may however be updated after coding one of the motion vectors. For example, the PMV_CANDS list may first be used for coding of a motion vector MV associated with a first motion compensation block, then PMV_CANDS may be updated using the vector MV (e.g. MV is added into the list), and then used for coding of a second motion compensation block. By subsequently updating PMV_CANDS with coded motion vectors, the list is updated according to a sliding window approach.

During encoding of a video, one or multiple PMV_CANDS lists may be maintained according to the sliding window approach, e.g. one for each frame type, one for each macroblock type, or one for each reference frame. When coding the two motion vectors associated with a bi-predicted motion compensation block, either a single or two different PMV_SAND may be used

Before a motion vector associated with a current motion compensation block is processed, the PMV_CANDS list used for coding the current motion vector may be updated by using motion vectors associated with surrounding blocks.

The PMV_CANDS list may be updated such that motion vectors associated with dose motion compensation blocks are inserted towards the beginning of the PMV_CANDS list (signaled with fewer bits), whereas motion vectors associated with more far away motion compensation blocks may be inserted towards the end of the PMV_CANDS list. Possible metrics to determine how far a motion compensation block is away from the current block include: the Euclidian distance (dx²+dy², where dx and dy are distances in the x and y directions, respectively), the Manhattan distance (the sum of absolute values, |dx|+|dy|), or the Chebyshev distance (the maximum of the absolute values, max(|dx|, |dy|), also known as maximum metric, chessboard distance, box distance, L_{∞} metric (L-infinity metric), L_{∞} norm). To this end, an outwards going scan may be performed around the current block to obtain motion vectors to update PMV_SANDS. The scan may be terminated when at least one of the following conditions is met:
all blocks of the current frame have been scanned,
all blocks of a pre-defined number of subsequent frames (e.g. the last frame) have been scanned
once a certain distance has been reached,
as soon as a pre-defined number of unique PMV candidates have been found,
all blocks of a predetermined scan pattern have been scanned.

Note that sorting the list on distances may be avoided in an outwards going scan, by inserting unique vectors at the end of the PMV_CANDS list, the list is kept sorted with the spatially closest vector first in the list.

In one embodiment the ordering is based on Euclidian distance to the block in question. Assume for instance that the block we wanted to encode was in position x=3 y=5. Then we would rank the surrounding blocks according to

euclidian_dist=sqrt((xpos−3)̂2+(ypos−5)̂2).

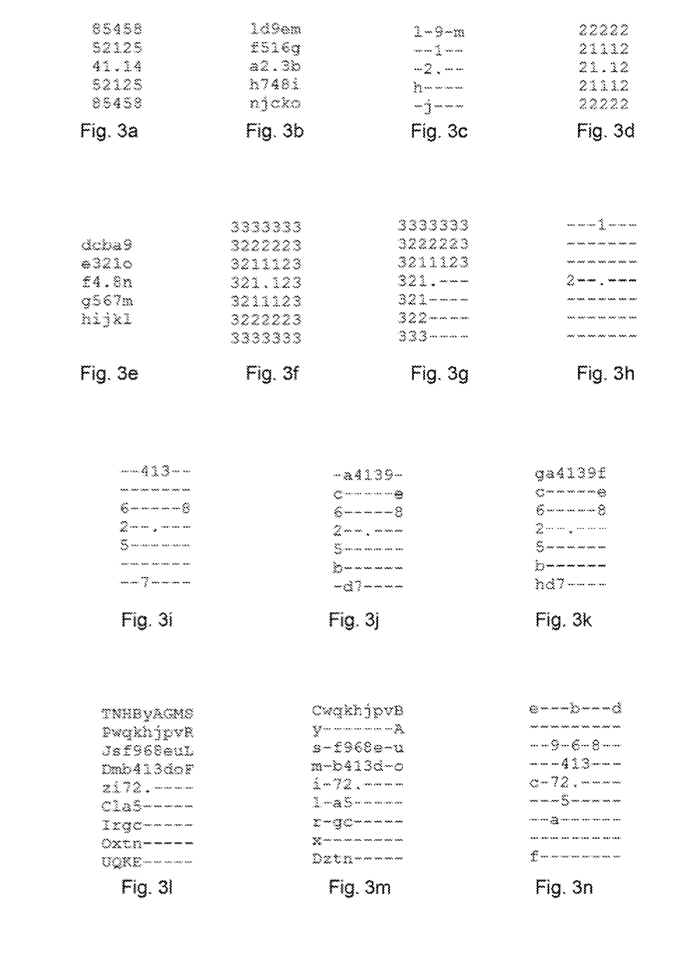

For instance, a block in position (2,1) would have a distance sqrt(1̂2+4̂2) sqrt(17). Since the square-root does not change the order it can be excluded. Thus, if the block marked with a dot in FIG. 3a is the one to be coded, the surrounding blocks would have the (squared) distances shown in FIG. 3a (this diagram shows only the nearest neighbors and, in practice would be extended outwards to the edge of the frame.

We then select blocks in an order that took the closest ones first, with some tie-breaking rule for blocks at the same distance. A possible order for the blocks shown in FIG. 3a is shown in FIG. 3b, where the order is shown according to: 1, 2, 3, . . . , 9, a, b, . . . .

Of course some of these would never be available, such as “3” and “b” since they are directly to the right of the block to be coded, and would therefore be coded after the present block. Other blocks would sometimes be available depending upon the traversal pattern used. Some blocks may not be available due to the simple fact that there was no motion vector present in that block, or that the motion vector present was the same as a block earlier in the sequence. After these considerations it is possible that only a subset of blocks have valid motion vectors. An example of such a subset is shown in FIG. 3c. In this case the list would consist of the motion vectors related to the shown blocks in the following order: 1, 2, 9, h, j, l, m.

A problem with this pattern is that it is quite hard to “spiral outwards”, that is: it is not easy to calculate which x,y-coordinate a candidate with rank k has. Of course, they could be stored in a long list (since mapping is deterministic) but that list could be huge.

Accordingly, an alternative embodiment is provided using an alternative structure for which it is easier to calculate the x,y-position of an element of a certain rank. This achieved by changing the distance metric from Euclidian distance to Chebyshev distance (also known as “box distance”). The new distance is instead calculated as

Chebyshev_dist=max(|xpos−xcurrent|,|ypos−ycurrent|),

In the example used above, where (xcurrent, ycurrent) (3, 5), a block in position (2,1) would have Chebyshev distance=4, since

$$\begin{matrix}Chebyshev\_dist = max ( \vert 2 - 3 \vert , \vert 1 - 5 \vert ) \\ = max ( \vert - 1 \vert , \vert - 4 \vert ) \\ = max ( 1 , 4 ) \\ = 4.\end{matrix}$$

The surrounding blocks would have the Chebyshev distances shown in FIG. 3d. This shows what looks like a square inside another square, or a box inside a box, hence the name box distance. Using Chebyshev distance it is a simple procedure to scan the candidates in order, for instance by first taking the top row, and then continuing anti-clockwise, as shown in FIG. 3e. This illustrates a spiral scan, because the scan order spirals outwards.

However, this ordering does have some problems. For instance, although blocks 3 and 4 have the same Chebyshev distance, block 4 has a lower Euclidian distance and so it would be appropriate to exchange the order of these two blocks. This problem is solved by using an order which is first determined by Chebyshev distance, and second by Euclidian distance. To clarify if two objects have different Chebyshev distance, the item with the smaller Chebyshev distance will always end up before the other one in the order. However, for items of the same Chebyshev distance, the order is determined by Euclidian distance. If two items have the same Chebyshev distance and the same Euclidian distance, a tie-breaking rule will be used. This provides an accurate ordering of the blocks that is still somewhat simple to calculate. An example of this ordering scheme will now be described. FIG. 3f shows the Chebyshev distances of blocks up to three rows or columns from a central current block. As shown in FIG. 3f, this gives several “layers” or squares of blocks with common Chebyshev distance. Further ordering can be provided by using a for-loop going over each layer (Chebyshev distance=1, 2, 3, etc.). In fact, since the blocks to the right and below the current block position have not been visited yet, and do not yet have motion vectors known for them, we can remove them from consideration. The resulting pattern is shown in FIG. 3g.

The remaining blocks are ordered as follows. Consider the layer of blocks with Chebyshev distance of 3. We then know that the items in the middle of each side of the layer will be the ones closest to the current block in a Euclidean sense, so we start by visiting them in some order, as shown in FIG. 3h. The second closest blocks will be the ones right next to these, so we proceed to next apply an order to these as shown in FIG. 3i. The next closest blocks will be those next to the ones just ordered as shown in FIG. 3j. Finally, the three corner blocks are placed in the order as shown in FIG. 3k.

We have now a finished layer 3, and would need to proceed to layer 4 if we had not found the required number of different motion vectors. A complete ordering for the blocks up to Chebyshev distance 4 is shown in FIG. 3l, where the order is shown as 1, 2, . . . 9, a, b, . . . z, A, B, . . . U.

A problem with this arrangement is that sometimes motion vectors close to the current block are all exactly the same. It has been identified as advantageous to discard such duplicates. However, a problem with the scan pattern of FIG. 3l is that a large number of the nearest neighbor backs must be investigated before any duplicates may be discarded. This means that a large number of vectors must sometimes be investigated before the candidate list can be filled and as such the above scan pattern can be considered to be slow.

Another disadvantage with the scan pattern of FIG. 3l is that motion vectors close to each other may be similar to each other even if they are not exactly the same. Thus the resulting list of PMVs may lack the diversity necessary encode motion vectors efficiently. For instance, the current block may be part of the background whereas all MVs 1, 2, . . . , 9, a, b, . . . , z, A, B, . . . , U may be part of a moving object. It could then be advantageous to be able to reach MVs corresponding to b her away (e.g., in layer 4, 5 etc) before filling up the list.

Accordingly, a further embodiment is provided which can be said to speed up the scan pattern. In this embodiment entire layers of blocks having common Chebyshev distance are excluded from consideration. For instance, we could use only layers that are powers of two: 1, 2, 4, 8, . . . . This is an example of an exponential increase, but any series which grows greater than a linear increase will provide a good trade off between a selection of blocks close to the current block and a few blocks a significant distance away. Using Chebyshev distances of 1, 2, 4, 8 etc, the ordering in this embodiment is shown in FIG. 3m.

However, even this pattern could require too many tests before growing the scan area big enough to capture distant blocks. In another alternative embodiment, all blocks other than the corner blocks and the blocks directly above and to the left of the current block are excluded. This pattern, combined with the above filtering mechanisms provides an ordering as shown in FIG. 3n.

The search pattern shown in FIG. 3n has been found to combine good compression efficiency (i.e., finding good motion vectors) with good computation performance.

Motion vectors to be added to a PMV_CANDS list may comprise spatial or temporal neighbors of the current block, or combinations of spatial and/or temporal neighbors, e.g. a H.264/AVC-style median predictor derived based on spatially neighboring blocks.

As an alternative to consideration of a pre-defined neighborhood to scan for motion vector candidates, it may be signaled from encoder to decoder (and thus dynamically decided at the encoder), for each motion vector or for a set of motion vectors (e.g. a macroblock), whether the associated motion vectors are to be added to the PMV_CANDS list.

Out of a set of possible mechanisms for determining motion vector candidates, one or a combination of mechanisms may be dynamically decided at the encoder and the decision then signaled to the decoder.

Limiting and/or reducing the number of candidates in PMV_CANDS can be helpful to reduce the overhead of signaling which PUN is used for motion vector prediction, since shorter lists require shorter code words. Additionally, restricting the addition of certain candidates can make room for other, more beneficial candidates to be added.

One measure for reducing the number of candidates is to avoid duplicate occurrences of the same motion vector in a given PMV_CANDS list. This car be done, when updating the list, by comparing the candidates already in the list with the new vector that could be added, and if a duplicate is found, either removing the duplicate vector or skipping the new vector. It is preferable to skip the new vector; otherwise a subsequent duplicate from a distant block may cause a candidate high in the order of the list to be put at the end of the list.

Removing or skipping new motion vectors may likewise be done for motion vectors that are similar but not equal, such as pairs of motion vectors that have a similarity measure smaller than a pre-defined threshold, where similarity measures could be Euclidian distance (x₀−x₁)²+(y₀−y₁)² or absolute distance |x₀−x₁|+|y₀−y₁|, with (x₀,y₀) and (x₁,y₁) being the pair of motion vectors under consideration. Rather than a straight distance measure, another approach is to look at the number of bits required to encode the distance between the motion vectors using a given encoding scheme.

Also, the number of candidates in PMV_CANDS may be limited to a pre-defined or dynamically obtained number. It is possible that once the number has been reached an additional candidate is to be added, then the candidate at the end of the PMV_CANDS list may be removed. This can be done because the candidate list is sorted such that the PMV candidate at the end of the list has been determined to be the least likely to be used.

Alternatively, removal of candidates from a PMV_CANDS list may be signaled explicitly from the encoder to the decoder (and thus decided dynamically by the encoder), e.g. by sending a code for removal of a motion vector candidate from a list along with an identifier of the motion vector, e.g. an index.

How to determine the order of motion vector candidates in candidate list will now be addressed. It is assumed that the candidates in PMV_CANDS are sorted, and use of one of the candidates in PMV_CANDS for prediction is signaled such that the first candidate in the list is assigned the shortest code word among the candidates and that subsequent candidates in the list are assigned code words with non-decreasing length. The following methods can be used when updating a PMV_CANDS list in order to sort the candidates in a way that is beneficial for overall coding efficiency.
The motion vectors corresponding to blocks that are close to the current block (using some distance metric) will get a position closer to the start of the list compared to motion vectors belonging to blocks that are further away from the current block.
The motion vector associated with the last coded block is placed at the beginning of the list (shortest code word). Alternatively, a combined candidate such as an H.264/AVC median predictor (or the like) for the current block is placed at the beginning of the list. Combining this approach with dynamic adaptation of PMV_CANDS list size allows guaranteed prediction performance of e.g. the H.264/AVC median predictor, since it is possible that PMV_CANDS list size is set to one, such that no bits need to be sent for index signaling.
The candidates can be sorted according to frequency of occurrence of the candidate (or other candidates with e.g. Euclidian or absolute distance below a pre-defined threshold) in previously coded blocks, such that vectors that describe typical motion in a video frame or sequence are assigned short code words. Alternatively, if a duplicate of a new candidate is already in the list, then the duplicate can be removed, and the new vector added at the beginning of the list, or as a further alternative the existing motion vector can be moved upwards one or more steps in the list.
It can further be useful to include weight with respect to motion compensation partition size, such that motion vectors with more weight are placed farther in the beginning of a PMV_CANDS list than those with lower weight. For instance, larger partitions could be trusted more than smaller partitions in the sense that the associated motion vectors may, depending on the coded sequence, more likely describe typical motion in that sequence. Thus motion vectors associated with larger partitions may be assigned more weight. Also, skip motion vectors may be trusted differently, e.g. assigned less weight, compared to non-skip motion vectors.

Alternatively, resorting of a PMV_CANDS list may be signaled explicitly from the encoder to the decoder (and thus decided dynamically by the encoder), e.g. by sending a code for resorting of a motion vector candidate from a list along with an identifier of the motion vector to be moved, e.g. an index, and a signal about where to move that candidate.

At the time when a motion vector candidate is added to or obtained from a PMV_CANDS list (in the latter case, in order to use it for prediction), it may be modified according to a pre-defined method. Since modification at time of adding (during encoding) or obtaining (during decoding) is equivalent, it may without loss of generality be assumed that vectors are modified at the time of obtaining. Such modifications at the time of obtaining may include:
Scaling of a motion vector candidate according to the frame distance of the reference frame to which the motion vector candidate is applied for prediction. For example, assume a candidate motion vector MV_{(T-1)}=(X,Y) in PMV_CANDS that has been applied for motion compensated prediction from a reference frame representing the video at time T−1, which is next to the current frame that is assumed to represent the video at time T. Now if this candidate is obtained from PMV_CANDS to be used for prediction of a motion vector pointing to a reference frame representing the video at time T−2 (two frames next to the current frame), then the motion vector magnitude can be scaled by a factor of 2, i.e. (2*X,2*Y). Also, if a candidate motion vector (X,Y) in the PMV_CANDS list refers to the video frame at T−2 is to be used for referencing the frame at T−1, the motion vector can be scaled to (X/2,Y/2). For both these cases we may end up duplicating a candidate motion vector in which case it can be removed. Scaling of candidate motion vectors is reasonable under the assumption of linear motion.
Similarly, when obtaining a motion vector predictor MV_{(T-1)}=(X,Y) in a B frame that represents time T, and that motion vector has been applied for motion compensated prediction from a left reference frame (time T−1), and now the predictor is to be used for prediction of a vector applied for motion compensated prediction from a right reference frame (time T+1), then the sign of the motion vector predictor is inverted, i.e. (−X,−Y).

The candidate predictor list size can be varied. Limiting and/or reducing the number of candidates in PMV_CANDS can be helpful to reduce the overhead of signaling which PMV is used for motion vector prediction, since shorter lists require shorter code words. On the other hand, depending on video sequence characteristics, it may be beneficial to have a larger number of motion vector prediction candidates e.g. in order to save bits for DMV coding in case of irregular motion. The following methods can be used to adapt the size of PMV_CANDS list according to video sequence characteristics.
The list size can be defined in the slice/frame/picture header or in a sequence-wide header (such as parameter set), i.e. signaled from the encoder to the decoder, and thus dynamically adapted by the encoder.
Candidates that have not been used for prediction during encoding of a number of previously coded blocks (according to a pre-defined threshold) can be removed from the list, thus reducing the list size.
The list size may be adapted according to similarity of candidates in the list. For example, when updating a list with a motion vector MV, the number of candidates that are similar to MV (according to a distance measure such as Euclidian or absolute distance, with a pre-defined threshold) are counted. A high count indicates a high number of similar candidates, and since it may not be necessary to have many similar candidates, at least one may be removed and the list size reduced. A low number of similar candidates on the other hand may indicate that it may be beneficial to have an additional candidate, thus the list size may be increased.

As mentioned above, the candidates in PMV_CANDS are sorted and the use of one of the candidates in PMV_CANDS is signaled such that the first candidate in the list is assigned the shortest code word among the candidates and that subsequent candidates in the list are assigned code words with non-decreasing length. Such code words can be defined e.g. according to Variable Length Coding (VLC) tables. The VLC table used can depend on the maximum number of candidates in PMV_SANDS (the list size), as e.g. dynamically adapted according to the methods above. Table 1 below presents some examples for VLC codes for different maximum list sizes. The left column shows the maximum list size, also denoted as C. In the right column, the VLC codes are shown along with indexes to address candidates in the PMV_CANDS list.

TABLE 1
Example VLC codes for different maximum list sizes.

| Maximum list | |
|---|---|
| size C | Index: VLC code |
| | 0: - (unambiguous, no signaling necessary) |
| 2 | 0: 0 |
| | 1: 1 |
| 3 | 0: 1 |
| | 1: 00 |
| | 2: 01 |
| 4 | 0: 1 |
| | 1: 00 |
| | 2: 010 |
| | 3: 011 |
| 5 | 0: 1 |
| | 1: 00 |
| | 2: 010 |
| | 3: 0110 |
| | 4: 0111 |
| 6 | 0: 1 |
| | 1: 010 |
| | 2: 011 |
| | 3: 001 |
| | 4: 0000 |
| | 5: 0001 |
| 7 | 0: 1 |
| | 1: 010 |
| | 2: 011 |
| | 3: 0010 |
| | 4: 0011 |
| | 5: 0000 |
| | 6: 0001 |

For bi-predicted motion compensation blocks, two motion vectors are coded, and thus two PMV candidates can be necessary. In that case the index numbers for the two PMV candidates can be coded together to further reduce the number of bits required for index coding. Table 2 shows an example for joint index coding, considering that both motion vectors use the same PMV_CANDS list, and that it is likely that both motion vectors use the same predictor in the PMV_CANDS list. Here idx0 and idx1 denote the indexes for first and second predictor, respectively. VLC0(idx,C) denotes a VLC for an index “idx” according to Table 1 considering a maximum list size of C.

TABLE 2
VLC code for coding of two candidates indexes associated with
bi-predicted block, C: maximum size of PMV_CANDS.

| Case | VLC code |
|---|---|
| idx1 < idx0 | VLC0 (idx0,C) 0 VLC0 (idx1,C-1) |
| idx1 = idx0 | VLC0 (idx0,C) 1 |
| idx1 > idx0 | VLC0 (idx0,C) 0 VLC0 (idx1-1,C-1) |

Unnecessary PMV candidates are removed from the list of PMV candidates. A mechanism for removing PMV candidates is required because it may happen that some candidates in the list will never be used, since choosing a candidate with a shorter codeword and encoding the distance will give a bit sequence that is shorter or of the same length compared for all possible motion vectors. In that case, they can be removed, thereby making the list shorter and the average bit length of each index shorter. As an alternative, it may be possible to instead insert more candidates. This way, the average bit length is kept the same, but the newly inserted candidate has a chance of being useful.

As an example, assume we have the following candidates:

| Value | Index | Code |
|---|---|---|
| (−1,2) | 0 | 1 |
| (13, 4) | 1 | 010 |
| (12, 3) | 2 | 011 |
| (0, 2) | 3 | 0010 |
| (3, 4) | 4 | 0011 |
| (−4, 1) | 5 | 0000 |
| (4, 8) | 6 | 0001 |

Also, assume that we encode a difference, DMV, (xdiff, ydiff) where xdiff and ydiff are encoded using Table 3 below. If we want to encode a motion vector, such as MV=(0,2), we can then encode it using candidate 3, which is PMV=(0,2), plus a difference DMV=(0,0):

PMV+DMV=MV

(0,2)+(0,0)=(0,2).

The index costs four bits (the code length for index 3 is four bits), and each of the zeroes in the difference cost one bit, so the total number of bits required to code MV=(0,2) is 4+1+1=6 bits.

However, we can also code the vector using index 0, PMV=(−1,2), plus a difference DMV=(1,0):

(−1,2)+(1,0)=(0,2).

The index costs one bit (the code length for index 1 is one bit), the xdiff=1 term in the difference costs three bits (see Table 3 below) and the ydiff=0 term costs one bit. Hence we get 1+3+1=5 bits in total, which is better than using index 3, which required 6 bits. It is easy to see given that the vector difference is coded using Table 3 below, that it will never be beneficial to use index 3, because using index 0 will always be one hit cheaper or better. Hence we can eliminate the candidate vector (0,2) and we get instead:

| Value | Index | Code |
|---|---|---|
| (−1,2) | 0 | 1 |
| (13, 4) | 1 | 010 |
| (12, 3) | 2 | 011 |
| (3, 4) | 4 | 001 |
| (−4, 1) | 5 | 0000 |
| (4, 8) | 6 | 0001 |

Index 4, vector (3,4) now has a shorter code; it is now three bits instead of four. Hence we have gained from the elimination if the vector (3,4) is used, and never lost anything. In the above example we removed the PMV candidate with index number 3, but it should be evident for a person ski d in the art that this is just an example. For instance, it may in some cases be beneficial to remove candidates 1 and 2 as well.

Since the same analysis is performed both in the encoder and the decoder, the same vector is removed from the list both in the encoder and the decoder. Hence, after the removal, both the encoder and the decoder will use the same candidate list.

Sometimes it may not be possible to ensure a gain by removing a single candidate, but it may be possible if two or more candidates are eliminated simultaneously. Another possibility is that altering the order of the candidates or even adding a new candidate to the list can allow us to remove candidates that have now been rendered unnecessary, and therefore be beneficial regardless of the final motion vector to be encoded,

TABLE 3
The cost of sending the differential

| Differential | Code |
|---|---|
| 0 | 1 |
| −1 | 010 |
| 1 | 011 |
| −2 | 00100 |
| 2 | 00101 |
| −3 | 00110 |
| 3 | 00111 |
| −4 | 0001000 |
| 4 | 0001001 |
| . . . | . . . |

The number of bits needed can be further reduced by not sending the sign bit, this is possible because in some circumstances the sign bit for the differential is unnecessary. Assume for example that we have the following list of PMV candidates:

| Value | Index | Code |
|---|---|---|
| (−1, 2) | 0 | 1 |
| (13, 8) | 1 | 010 |
| (3, 4) | 2 | 011 |
| (11, 3) | 3 | 0010 |
| (12, 3) | 4 | 0011 |
| (1, 2) | 5 | 0000 |
| (4, 8) | 6 | 0001 |

Assume that we want to encode a vector using PMV candidate having index number 3, PMV=(11,3). Since the PMV candidate with index number 4 is to the right of it (having coordinates PMV=(12,3)), it is advantageous to encode it with candidate 4 instead if the x-coordinate is 12 or greater. As an example, the vector MV=(15,2) can be encoded using candidate 3 as

(11,3)+(4,−1)

costing four bits for the index, seven bits for +4 and three bits for −1 (see table 3), in total 14 bits. But it can also be encoded using candidate 4 as

(12,3)+(3,−1)

which costs four bits for the index, five bits for +3 and three bits for −1, in total 12 bits. Since candidate 4 will always be closer to any point in the right half-plane, it will be advantageous to choose candidate 4 for that. Likewise, it is better to choose candidate 3 if we are in the left half-plane (as seen from the point between (11,3) and (12,3)).

This means that it is unnecessary to specify the sign bit for the differential in the x-component, since it will always be negative for (11.3) and positive for (12,3). The sign bit is the last bit in Table 3, except for 0 which does not have a sign bit. This means that if either candidate 3 or 4 will be selected, they will be one bit cheaper to encode.

The decoder will of course do the same analysis and avoid reading the sign bit if the above situation has occurred.

Even if the candidates are not exactly next to each other, or if they do not have exactly the same cost, it may be possible to avoid sending the sign bit, at least for one of the candidates. As an example, assume we want to encode a value using PMV candidate with index number 5, PMV=(12). If the x-coordinate for the vector to encode is smaller than or equal to zero, it is always advantageous to instead use candidate 0, since it has a lower cost. This means that the sign bit for the x-coordinate does not have to be sent for candidate 5. However, it may not be possible to remove the sign bit for the x-component for candidate 0. Since its index value is so inexpensive to code, it may be advantageous to choose it even if the vector to code is to the right of candidate 5.

If index 0 had the same cost as index 4, both candidates would be equally good to encode a vector with an x-coordinate of 0. However, we could decide to always use the lowest index in such oases, and thus still avoid sending the sign bit when index 4 is selected. If the vectors are in the same row (as above), or indeed in the same column, it is possible to derive a general expression for when it is never useful to send the sign bit, as follows.

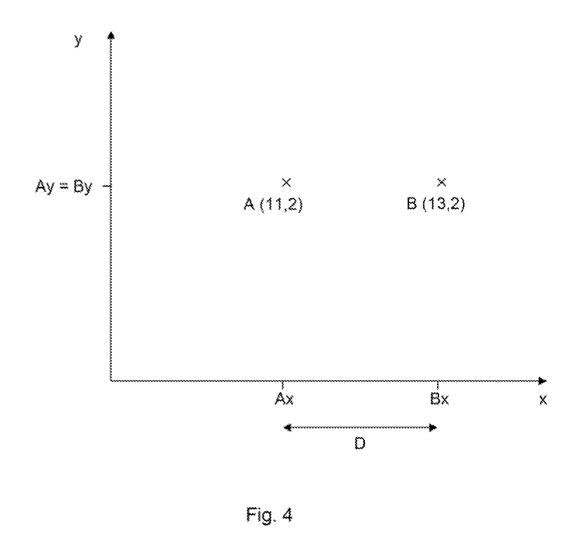

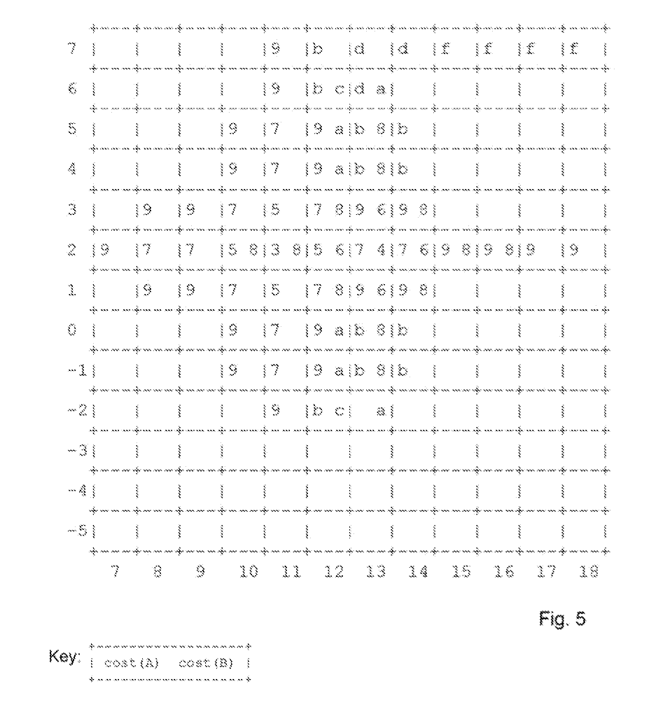

Referring to FIG. 4, assume that we have two candidates A=(Ax, Ay) and B=(Bx, By) on the same row (so By=Ay) and that the distance between them is D so that Bx=Ax+D. In the following we will assume that D is positive, but a person skilled in the art will appreciate that it also work if we switch places for A and B. Assume further that it is never more costly to transmit the index for candidate A than B, i.e., cost(A_index)<=cost(B_index), where cost(A_index) is the cost of transmitting the index associated with candidate A. Denote the cost of sending the differential k in the x-direction cost_x(k). For instance, cost_x(−3) equals 5 according to Table 3.

Now, if cost(A_index)−cost(B_index)+cost_x(D−1)−3<=0, we do not have to send the sign bit for candidate B. As an example, if A=(11,2), B=(13,2) and A_index is 1 and B_index is 0001, then 0=2 and cost(A_index)−cost(B_index)+cost_x(D−1)−3 equals 1−4+3−3=−2 which is smaller than 0, hence we do not need to send the sign bit for B. This example is illustrated in FIG. 5, where the x and y axis show x and y components of motion vectors. Each box in FIG. 5 represents a motion vector: the bit cost of coding the respective motion vector using PMV candidate A is shown to the left of the box and the bit cost of coding the respective motion vector using PMV candidate B is shown to the right of the box. From FIG. 5 it can be seen that for MVs with an x component of 12 or less the most efficient PMV to use is A, whereas for MVs with an x component of 13 or more, the most efficient PMV to use is B.

In one embodiment of the proposed solution, we use a maximum of four candidates in the list. However, in another embodiment, we use seven, and there is in principle no limit to the maximum. If we allow for a bigger maximum, the list can grow and chances increase that a suitable vector can be found. On the other hand, the number of bits needed to specify the candidate vector also increases. On top of that we get the problem that many vectors can be represented using several candidates, which is unnecessary. This redundant representation grows the more vectors are added.

One way to avoid this redundant representation is to restrict the number of vectors that it is possible to encode with each candidate vector. For example, it is possible to restrict a certain candidate so that it can only encode motion vectors that are exactly equal to the candidate, or differs in one step in one direction. This can be done by changing the way the differential is encoded. Usually the differential is encoded using Table 3, with separate encoding for x and y. Instead, we could use the following short table:

| Differential | Code |
|---|---|
| (0, 0) | 1 |
| (−1, 0) | 000 |
| 0, −1) | 001 |
| (1, 0) | 010 |
| (0, 1) | 011 |

This restricted coding of the differential may be employed for candidates above a certain index. For instance, all candidates with index 3 or higher could be encoded this way.

This has at least two advantages:

1) The coding of the differential becomes very short, which is good since the cost of signaling index 3 or higher is quite high; and

2) The candidate will not spend bits on covering motion vectors that would anyway be better encoded using some of the other candidate vectors. The redundancy problem described above is thereby ameliorated.

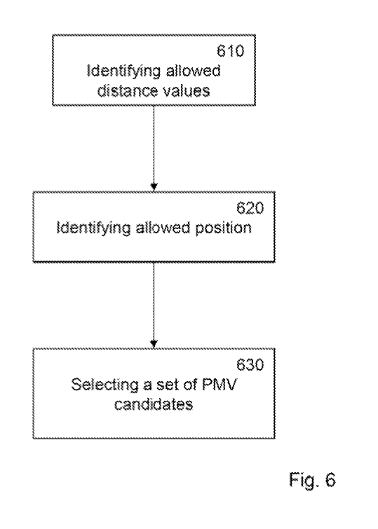

FIG. 6 illustrates a method according to the present application. At 610 allowed distance values are identified for the distances between a current block and a previous block. The previous block may have a motion vector associated therewith which was used for coding said previous block. Optionally, at 620 allowed positions for previous blocks may be identified. Such allowed positions may comprise middle and corner positions in a square of blocks centered on the current block. At 630 a set of PMV candidates is selected as a subset of the previously used motion vectors associated with previous blocks having allowed distance values, and, if optional step 620 is implemented, allowed positions. The set of PMV candidates may then used for coding of the current block.

The methods and apparatus described herein improve coding efficiency for motion vector prediction schemes that use signaling of motion vector predictor.

It will be apparent to the skilled person that the exact order and content of the actions carried out in the method described herein may be altered according to the requirements of a particular set of execution parameters. Accordingly, the order in which actions are described and/or claimed is not to be construed as a strict limitation on order in which actions are to be performed.

Further, while examples have been given in the context of particular coding standards, these examples are not intended to be the limit of the coding standards to which the disclosed method and apparatus may be applied. For example, while specific examples have been given in the context of H.264/AVC, the principles disclosed herein can also be applied to an MPEG2 system, other coding standard, and indeed any coding system which uses predicted motion vectors.

1. A method of selecting Predicted Motion Vector candidates (PMV candidates), wherein each PMV candidate corresponds to a motion vector used for coding of a previous block, said previous block having a distance from a current block, the method comprising:
identifying allowed distance values of distances between the current block and the previous block;
selecting a set of PMV candidates as a subset of a set of previously coded motion vectors that were used for previous blocks having an allowed distance from the current block.

2. The method of claim 1, further comprising identifying allowed positions of previous blocks, and wherein the selected set of PMV candidates comprises a subset of the set of previously coded motion vectors that were used for previous blocks having an allowed distance from the current block and an allowed position.

3. The method of claim 2, wherein the allowed positions are corner and middle block positions.

4. The method of claim 1, wherein the allowed distance values are predetermined.

5. The method of claim 2, wherein the allowed positions are predetermined.

6. The method of claim 1, wherein the allowed distance values comprise elements of a series, the elements in the series increasing at a rate greater than a linear increase.

7. The method of claim 6, wherein the values of distance for the selected set of PMV candidates increase according to at least one of:
a geometric progression; and
an exponential progression.

8. The method of claim 1, the method further comprising removing unnecessary PMV candidates from the set of PMV candidates.

9. The method of claim 1, the method for video encoding or for video decoding, wherein the current block is the block being encoded or decoded respectively.

10. The method of claim 1, the method further comprising ordering the PMV candidates in the set of PMV candidates according to expected usage of PMV.

11. The method of claim 10, wherein the expected usage is obtained from previous frequency of use.

12. The method of claim 1, wherein the distance is measured as a Euclidean distance.

13. The method of claim 12, further comprising:
ordering the PMV candidates according to their Euclidean distance.

14. The method of claim 1, wherein the distance is measured as Chebyshev distance.

15. The method of claim 14, further comprising:
ordering the PMV candidates according to their Chebyshev distance.

16. The method of claim 15, further comprising:
further ordering the PMV candidates according to their Euclidean distance.

17. A video encoding apparatus comprising a processor arranged to:
identify allowed distance values of distances between a current block and a previous block, wherein each Predicted Motion Vector candidate (PMV candidate) corresponds to a motion vector used for coding of a previous block, said previous block having a distance from the current block;
select a set of PMV candidates as a subset of a set of previously coded motion vectors that were used for previous blocks having an allowed distance from the current block.

18. A video decoding apparatus comprising a processor arranged to:
identify allowed distance values of distances between a current block and a previous block, wherein each Predicted Motion Vector candidate (PMV candidate) corresponds to a motion vector used for coding of a previous block, said previous block having a distance from the current block;
select a set of PMV candidates as a subset of a set of previously coded motion vectors that were used for previous blocks having an allowed distance from the current block.

19. A computer-readable medium, carrying instructions, which, when executed by computer logic, causes said computer logic to carry out the method of claim 1.
